(19) United States
(12) Patent Application Publication
(10) Pub. No.: US 2025/0365116 A1
(43) Pub. Date: Nov. 27, 2025

(54) METHOD AND USER EQUIPMENT FOR PERFORMING UPLINK TRANSMISSIONS TO MULTIPLE TRANSMISSION RECEPTION POINTS

(71) Applicant: MEDIATEK INC., Hsinchu City (TW)

(72) Inventors: Cheng-Rung TSAI, Hsinchu City (TW); Yi-Ru CHEN, Hsinchu City (TW)

(21) Appl. No.: 18/872,345

(22) PCT Filed: Jun. 30, 2023
(86) PCT No.: PCT/CN2023/104348

§ 371 Date: Dec. 6, 2024

Related U.S. Application Data
(60) Provisional application No. 63/369,262, filed on Jul. 25, 2022.

(51) Int. Cl. H04L 5/00; H04W 28/06; H04W 72/231

(52) U.S. Cl. CPC H04L 5/0053; H04L 5/0035; H04W 28/06; H04W 72/231

(57) ABSTRACT

Method and UE are provided for performing UL transmissions to multiple TRPs. In particular, a UE can determine whether two UL transmissions are associated with one TRP before being transmitted, and the two UL transmissions are overlapped in at least one symbol in time domain. In an event that the first UL transmission and the second UL transmission are associated with the TRP, the UE can drop one UL transmission and perform the other UL transmission, or multiplex two UL transmissions for transmission.

### CROSS REFERENCE TO RELATED APPLICATIONS

This application claims the benefit under 35 U.S.C. §119 from U.S. provisional application Ser. No. 63/369,262, entitled “Uplink Transmissions to Multiple Transmission Reception Points,” filed on Jul. 25, 2022, the subject matter of which is incorporated herein by reference.

### TECHNICAL FIELD

The disclosed embodiments relate generally to wireless communication, and, more particularly, to method and user equipment for performing uplink (UL) transmissions to multiple transmission reception points (TRPs).

### BACKGROUND

In conventional network of 3rd Generation Partnership Project (3GPP) 5G New Radio (NR), a user equipment (UE) is configured with multi-downlink control information (M-DCI) for performing UL transmissions with a plurality of TRPs in one serving cell. In a latest 5G NR network, if the UE performs different UL transmissions that are timely overlapped and transmitted to the same TRP, it is considered as a collusion and the UE is not allowable to perform such UL transmissions. If the UE performs different UL transmissions that are timely overlapped and transmitted to different TRPs, the UE should be allowable to perform such transmissions. However, the latest 5G NR network may not allow the UE to perform such UL transmissions. As that, the UE is confused about whether to perform such different UL transmissions to one TRP or to more TRPs.

Therefore, a solution is sought.

### SUMMARY

Method and UE are provided for performing UL transmissions to multiple TRPs. In particular, a UE can determine whether two UL transmissions are associated with one TRP before being transmitted, and the two UL transmissions are overlapped in at least one symbol in time domain. In an event that the first UL transmission and the second UL transmission are associated with the TRP, the UE can drop one UL transmission and perform the other UL transmission or multiplex two UL transmissions for transmission.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G NR network for a plurality of TRPs in accordance with aspects of the current invention.

FIG. 2 is a simplified block diagram of one TRP and the UE in accordance with aspects of the current invention.

FIG. 3 illustrates one proposed scenario for a UE performing UL transmissions to one TRP in accordance with aspects of the current invention.

FIG. 4 illustrates one proposed scenario for a UE performing UL transmissions to one TRP in accordance with aspects of the current invention.

FIG. 5 is a flow chart of a method for a UE performing UL transmissions to one TRP in accordance with aspects of the current invention.

FIG. 6 is a flow chart of another method for a UE performing UL transmissions to one TRP in accordance with aspects of the current invention.

### DETAILED DESCRIPTION

Reference will now be made in detail to some embodiments of the invention, examples of which are illustrated in the accompanying drawings.

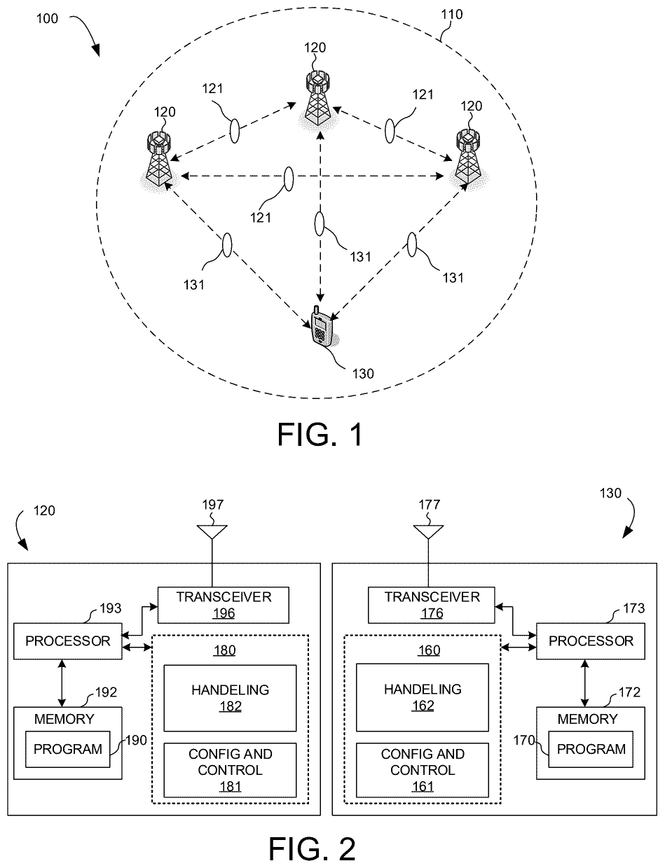

FIG. 1 illustrates an exemplary 5G NR network 100 for a plurality of TRPs in accordance with aspects of the current invention. The 5G NR network 100 includes a cell 110 that covers at least one UE 130 communicatively connected to a plurality of transmission reception points (TRPs) 120. Each TRP 120 may provide radio access using a Radio Access Technology (RAT) (e.g., the 5G NR technology). The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

Each TRP 120 being functionally similar to the BS may provide communication coverage for a geographic coverage area in which communications with the UE 130 is supported via a communication link 131. The communication links 131 shown in the 5G NR network 100 may respectively include UL transmissions from the UE 130 to the TRPs 120 (e.g., on the Physical Uplink Control Channel (PUCCH) or Physical Uplink Shared Channel (PUSCH)) or downlink (DL) transmissions from the TRPs 120 to the UE 130 (e.g., on the Physical Downlink Control Channel (PDCCH) or Physical Downlink Shared Channel (PDSCH)). The TRPs 120 may communicate with each other via a communication link 121.

FIG. 2 is a simplified block diagram of one TRP 120 and the UE 130 in accordance with aspects of the current invention. For the TRP 120, an antenna 197 transmits and receives radio signal. A radio frequency (RF) transceiver module 196, coupled with the antenna, receives RF signals from the antenna, converts them to baseband signals and sends them to processor 193. RF transceiver 196 also converts received baseband signals from the processor 193, converts them to RF signals, and sends out to antenna 197. Processor 193 processes the received baseband signals and invokes different functional modules and circuits to perform features in the TRP 120. Memory 192 stores program instructions and data 190 to control the operations of the TRP 120.

Similarly, for the UE 130, antenna 177 transmits and receives RF signals. RF transceiver module 176, coupled with the antenna, receives RF signals from the antenna, converts them to baseband signals and sends them to processor 173. The RF transceiver 176 also converts received baseband signals from the processor 173, converts them to RF signals, and sends out to antenna 177. Processor 173 processes the received baseband signals and invokes different functional modules and circuits to perform features in the UE 130. Memory 172 stores program instructions and data 170 to control the operations of the UE 130. Although a specific number of transceiver 176 and antenna 177 are depicted in FIG. 2, it is contemplated that any number of transceiver 176 and antenna 177 may be included in the UE 130 for communicating with multiple TRPs 120 simultaneously.

The TRP 120 and the UE 130 also include several functional modules and circuits that can be implemented and configured to perform embodiments of the present invention. In the example of FIG. 2, the TRP 120 includes a set of control functional modules and circuit 180. Handling circuit 182 handles a TA command for multiple TRPs and associated with one TAG via a TAG identification (ID). Configuration and control circuit 181 provides different parameters to configure and control the UE 130. The UE 130 includes a set of control functional modules and circuit 160. Handling circuit 162 handles a TA command for multiple TRPs and associated with one TAG via a TAG ID. Configuration and control circuit 161 handles configuration and control parameters from the TRPs 120.

Note that the different functional modules and circuits can be implemented and configured by software, firmware, hardware, and any combination thereof. The function modules and circuits, when executed by the processors 193 and 173 (e.g., via executing program codes 190 and 170), allow the TRPs 120 and the UE 130 to perform embodiments of the present invention.

As shown in FIG. 1, the UE 130 is configured with M-DCI for performing UL transmissions with the plurality of TRPs 120 (e.g., there are three TRPs including one in the left, one in the middle and one in the right) in the cell 110, which is a M-DCI based MTRP scheme. If the UE 130 performs different UL transmissions that are timely overlapped (e.g., the UL transmissions being overlapped at least in one symbol in time domain) and transmitted to the same TRP (e.g., the left TRP), it is considered as a collusion and the UE is allowable to perform such UL transmissions. However, if the UE 130 performs different UL transmissions that are timely overlapped (e.g., the UL transmissions being overlapped at least in one symbol in time domain) and transmitted to different TRPs (e.g., to the left TRP and the right TRP), the UE should be allowable to perform such transmissions. However, the latest 5G NR network may not allow the UE to perform such UL transmissions. Since the UE is confused about whether to perform such different UL transmissions to one TRP or to more TRPs, it is proposed scenarios below for clearly specify when and how to perform different UL transmissions to different TRPs, respectively.

Initially, based on the M-DCI based MTRP scheme, it shares the similar assumption that one UE (e.g., UE 130) and the plurality of TRPs (e.g., TRPs 120) are in one cell (e.g., cell 110). In addition, at least two UL transmissions (e.g., a first UL transmission and a second UL transmission) of the UE are pending for transmission. Specifically, the UE can perform the two UL transmissions via one or more than one TRPs after receiving scheduling configurations. Based on different scheduling configurations, the two UL transmission may be timely overlapped (e.g., being overlapped at least in one symbol in time domain) or may be timely irrelevant (e.g., being non-overlapped in time domain).

The first UL transmission or the second UL transmission can be a PUSCH or a PUCCH. For example, both two UL transmissions are the PUSCH, or both two UL transmissions are the PUCCH, or one UL transmission is the PUCCH and the other UL transmission is the PUSCH. Specifically, the PUCCH may be a UL control channel to periodically report a channel state information (CSI) report to the UE, and the PUSCH may be a UL shared channel (UL-SCH) for data transmission (e.g., a semi-persistent CSI report or other types of data transmission) between the UE and the TRP.

In a first scenario, it is assumed that the first UL transmission and the second UL transmission are timely overlapped (i.e., being overlapped in at least one symbol). In order to determine whether a collision of the first and second UL transmission is occurred, the UE determines whether the first UL transmission and the second UL transmission are associated with one TRP before performing the first UL transmission and the second UL transmission in the cell. If the first UL transmission and the second UL transmission are associated with the same TRP, the UE determines that a potential collision exists between the first and second UL transmissions and does not perform the first UL transmission and the second UL transmission. Instead, the UE drops one of the first UL transmission and the second UL transmission (e.g., dropping the first UL transmission) and performs the other of the first UL transmission and the second UL transmission (e.g., performing the second UL transmission) to avoid the potential collision between the first and second UL transmission.

Specifically, the UE receives a first radio resource control (RRC) from one TRP to configure a first control resource set (CORESET) parameter associated with the first UL transmission and a second CORESET parameter associated with the second UL transmission. In order to determining whether a collision between the first and second UL transmission is occurred, the UE determines whether the first CORESET parameter of the first UL transmission is identical to the second CORESET parameter of the second UL transmission. If the first CORESET parameter is identical to the second CORESET parameter, the UE determines that the potential collision between the first and sconed UL transmission exists.

Alternatively, the UE receives a signaling from one TRP to configure a first transmission configuration indication (TCI) state associated with the first UL transmission and a second TCI state associated with the second UL transmission. In order to determining whether a collision of the first and second UL transmission is occurred, the UE determines whether the first TCI state of the first UL transmission is identical to the second TCI state of the second UL transmission. If the first TCI state is identical to the second TCI state, the UE determines that the potential collision between the first and sconed UL transmission exists.

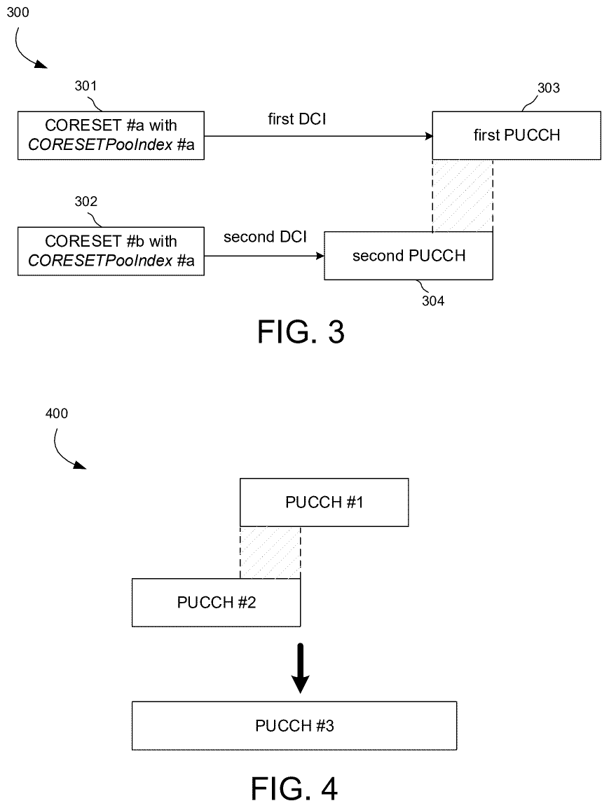

FIG. 3 illustrates one proposed scenario 300 for a UE performing UL transmissions to one TRP in accordance with aspects of the current invention. As shown in FIG. 3, the UE is configured with two CORESETs (e.g., a first CORESET #a and a second CORESET #b), as shown in blocks 301 and 302. The first CORESET (e.g., CORESET #a) includes a first CORESET parameter with its value (e.g., CORESETPoolIndex #a), and the second CORESET (e.g., CORESET #b) includes a second CORESET parameter with its value (e.g., CORESETPoolIndex #a). Then, the UE monitors in the two CORESETs for first DCI and the second DCI. Moving to blocks 303 and 304, the first DCI schedules the first PUCCH and the second DCI schedules the second PUCCH, and the first PUCCH and the second PUCCH are timely overlapped.

As shown in FIG. 3, since the value of the first CORESET parameter (e.g., CORESETPoolIndex #a) is identical to the value of the second CORESET parameter (e.g., CORESETPoolIndex #a), the UE determines that the first UL transmission and the second UL transmission are collided. If the first UL transmission includes CSI report and the second UL transmission includes a data transmission on the UL-SCH, the UE can drop the first UL transmission and perform the second UL transmission, so as to avoid a potential collision between the first and second UL transmission.

Based on illustrations of FIG. 3, similar block diagrams and operations can be applied for determining whether the first TCI state of the first UL transmission is identical to the second TCI state of the second UL transmission, which is neglected hereinafter for brevity.

In a second scenario, it is also assumed that the first UL transmission and the second UL transmission are timely overlapped (i.e., being overlapped in at least one symbol). Further, the UE determines whether the first UL transmission and the second UL transmission are associated with one TRP before performing the first UL transmission and the second UL transmission in the cell. If the first UL transmission and the second UL transmission are associated with the same TRP, the UE determines that a potential collision exists between the first and second UL transmission and does not perform the first UL transmission and the second UL transmission. Instead, the UE multiplexes the first UL transmission and the second UL transmission for transmission to avoid the potential collision between the first and second UL transmission.

For determining whether a potential collision exists between the first and second UL transmission, if both the first UL transmission and the second UL transmission correspond to the PUCCH, the UE can determine whether the first UL transmission and the second UL transmission belong to a PUCCH group (e.g., checking PUCCH group indexes of the first UL transmission and of the second UL transmission). If the first UL transmission and the second UL transmission belong to the same PUCCH group (i.e., having the same PUCCH group index), it is determined that the first UL transmission and the second UL transmission are associated with the same TRP with a potential collision therebetween. As that, the UE can merge both the first UL transmission and the second UL transmission into the same UL resource for transmission.

Considering an application of the second scenario, the UE can receive a second RRC to configure resources for the first UL transmission and the second UL transmission, respectively. Specifically, the second RRC includes a multi-CSI-PUCCH-ResourceList parameter to separately configure the CSI reporting resources for the first UL transmission as well as the second UL transmission.

FIG. 4 illustrates one proposed scenario 400 for a UE performing UL transmissions to one TRP in accordance with aspects of the current invention. As shown in FIG. 4, both the first UL transmission and the second UL transmission correspond to a PUCCH (e.g., PUCCH #1 and

PUCCH #2) for transmitting to one TRP and have at least one symbol timely overlapped. If it is determined that the first UL transmission and the second UL transmission belong to the same PUCCH group, the UE can multiplex PUCCH #1 with PUCCH #2 to form a new PUCCH #3. Specifically, the UE can multiplex a first CSI report on the PUCCH #1 with a second CSI report on the PUCCH #2 and perform the single UL transmission on PUCCH #3, so as to avoid collision between PUCCH #1 and PUCCH #2.

The above scenarios are applied to deal with two UL transmission with a potential collision. If the UE has the capability to support more than two UL transmissions that are transmitted to the same TRP, the UE, after determining a potential collision exists between the multiple UL transmission, can multiplex multiple UL transmissions into a single UL transmission, the UE can select only one UL transmission for transmission and drop other UL transmissions.

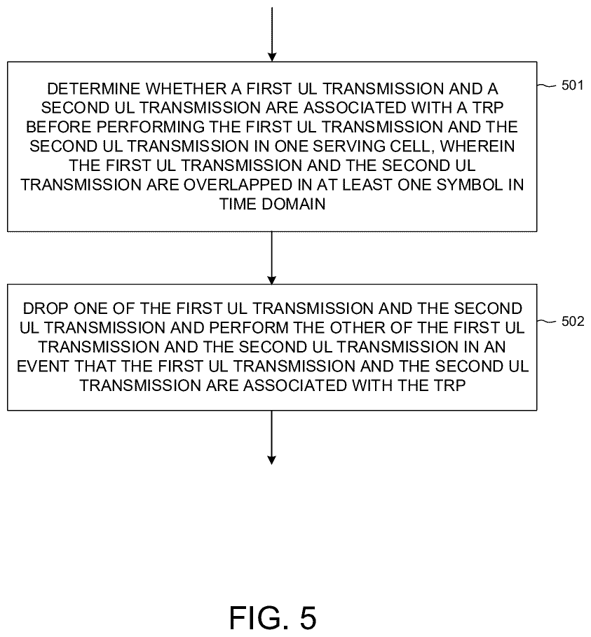

FIG. 5 is a flow chart of a method for a UE performing UL transmissions to one TRP in accordance with aspects of the current invention. In step 501, the UE determines whether a first UL transmission and a second UL transmission are associated with a TRP before performing the first UL transmission and the second UL transmission in one serving cell, wherein the first UL transmission and the second UL transmission are overlapped in at least one symbol in time domain. In step 502, the UE drops one of the first UL transmission and the second UL transmission and performs the other of the first UL transmission and the second UL transmission in an event that the first UL transmission and the second UL transmission are associated with the TRP.

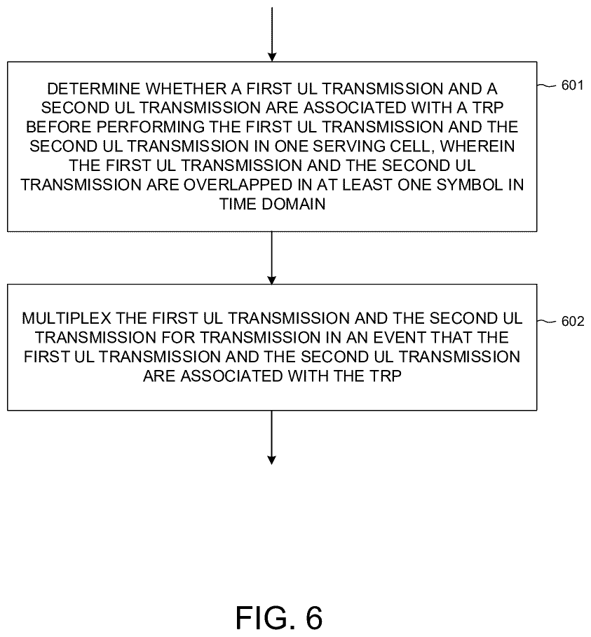

FIG. 6 is a flow chart of another method for a UE performing UL transmissions to one TRP in accordance with aspects of the current invention. In step 601, the UE determines whether a first UL transmission and a second UL transmission are associated with a TRP before performing the first UL transmission and the second UL transmission in one serving cell, wherein the first UL transmission and the second UL transmission are overlapped in at least one symbol in time domain. In step 602, the UE multiplexes the first UL transmission and the second UL transmission for transmission in an event that the first UL transmission and the second UL transmission are associated with the TRP.

In some embodiments, the UE further determines whether a first CORESET parameter of the first UL transmission is identical to a second CORESET parameter of the second UL transmission. Alternatively, the UE further determines whether a first TCI state of the first UL transmission is identical to a second TCI state of the second UL transmission.

In some embodiments, the UE further receives a first RRC to configure the first CORESET parameter and the second CORESET parameter or receives a signaling to configure the first TCI state and the second TCI state, wherein the first UL transmission or the second UL transmission corresponds to a PUSCH or a PUCCH.

In some embodiments, the first CORESET parameter includes a first CORESETPoolIndex value, and the second CORESET parameter includes a second CORESETPoolIndex value.

In some embodiments, in an event that both the first UL transmission and the second UL transmission correspond to a PUCCH, the UE further determines whether the first UL transmission and the second UL transmission belong to a PUCCH group.

In some embodiments, in an event that the first UL transmission includes a CSI report and the second UL transmission includes a transmission on UL-SCH, the UE further drops the first UL transmission and performs the second UL transmission.

In some embodiments, the UE further receives a second RRC to configure resources for the first UL transmission and the second UL transmission.

In some embodiments, the second RRC includes a multi-CSI-PUCCH-ResourceList parameter.

In some embodiments, the UE further multiplexes a first CSI report of the first UL transmission with a second CSI report of the second UL transmission.

In some embodiments, a M-DCI based MTRP scheme is configured to the UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
determining, by a user equipment (UE), whether a first uplink (UL) transmission and a second UL transmission are associated with a transmission reception point (TRP) before performing the first UL transmission and the second UL transmission in one serving cell, wherein the first UL transmission and the second UL transmission are overlapped in at least one symbol in time domain; and
dropping, by the UE, one of the first UL transmission and the second UL transmission and performing the other of the first UL transmission and the second UL transmission in an event that the first UL transmission and the second UL transmission are associated with the TRP; or
multiplexing, by the UE, the first UL transmission and the second UL transmission for transmission in an event that the first UL transmission and the second UL transmission are associated with the TRP.

2. The method of claim 1, wherein the step of determining whether the first UL transmission and the second UL transmission are associated with the TRP further comprises:
determining, by the UE, whether a first control resource set (CORESET) parameter of the first UL transmission is identical to a second CORESET parameter of the second UL transmission; or
determining, by the UE, whether a first transmission configuration indication (TCI) state of the first UL transmission is identical to a second TCI state of the second UL transmission.

3. The method of claim 2, further comprising:
receiving, by the UE, a first radio resource control (RRC) to configure the first CORESET parameter and the second CORESET parameter; or
receiving, by the UE, a signaling to configure the first TCI state and the second TCI state,
wherein the first UL transmission or the second UL transmission corresponds to a physical uplink shared channel (PUSCH) or a physical uplink control channel (PUCCH).

4. The method of claim 3, wherein the first CORESET parameter comprises a first CORESETPoolIndex value, and the second CORESET parameter comprises a second CORESETPoolIndex value.

5. The method of claim 1, wherein in an event that both the first UL transmission and the second UL transmission correspond to a physical uplink control channel (PUCCH), the step of determining whether the first UL transmission and the second UL transmission are associated with the TRP further comprises:
determining, by the UE, whether the first UL transmission and the second UL transmission belong to a PUCCH group.

6. The method of claim 1, wherein in an event that the first UL transmission comprises a channel state information (CSI) report and the second UL transmission comprises a transmission on uplink shared channel (UL-SCH), the method further comprises:
dropping, by the UE, the first UL transmission and performing the second UL transmission.

7. The method of claim 1, further comprising:
receiving, by the UE, a second radio resource control (RRC) to configure resources for the first UL transmission and the second UL transmission.

8. The method of claim 7, wherein the second RRC comprises a multi-CSI-PUCCH-ResourceList parameter.

9. The method of claim 1, wherein the step of multiplexing the first UL transmission and the second UL transmission for transmission in an event that the first UL transmission and the second UL transmission are associated with the TRP further comprises:
multiplexing, by the UE, a first channel state information (CSI) report of the first UL transmission with a second CSI report of the second UL transmission.

10. The method of claim 1, wherein a multi-downlink control information (M-DCI) based multi-TRP (MTRP) scheme is configured to the UE.

11. A user equipment (UE), comprising:
a transceiver; and
a transmission handling circuit that:
determines whether a first uplink (UL) transmission and a second UL transmission are associated with a transmission reception point (TRP) before performing the first UL transmission and the second UL transmission in one serving cell, wherein the first UL transmission and the second UL transmission are overlapped in at least one symbol in time domain; and
drops one of the first UL transmission and the second UL transmission and performs the other of the first UL transmission and the second UL transmission in an event that the first UL transmission and the second UL transmission are associated with the TRP; or
multiplexes the first UL transmission and the second UL transmission for transmission in an event that the first UL transmission and the second UL transmission are associated with the TRP.

12. The UE of claim 11, wherein the transmission handling circuit further:
determines whether a first control resource set (CORESET) parameter of the first UL transmission is identical to a second CORESET parameter of the second UL transmission; or
determines whether a first transmission configuration indication (TCI) state of the first UL transmission is identical to a second TCI state of the second UL transmission.

13. The UE of claim 12, wherein the transmission handling circuit further:
receives, via the transceiver, a first radio resource control (RRC) to configure the first CORESET parameter and the second CORESET parameter; or
receives, via the transceiver, a signaling to configure the first TCI state and the second TCI state,
wherein the first UL transmission or the second UL transmission corresponds to a physical uplink shared channel (PUSCH) or a physical uplink control channel (PUCCH).

14. The UE of claim 13, wherein the first CORESET parameter comprises a first CORESETPoolIndex value, and the second CORESET parameter comprises a second CORESETPoolIndex value.

15. The UE of claim 11, wherein in an event that both the first UL transmission and the second UL transmission correspond to a physical uplink control channel (PUCCH), the transmission handling circuit further:
determines whether the first UL transmission and the second UL transmission belong to a PUCCH group.

16. The UE of claim 11, wherein in an event that the first UL transmission comprises a channel state information (CSI) report and the second UL transmission comprises a transmission on uplink shared channel (UL-SCH), the transmission handling circuit further:
drops the first UL transmission and performs the second UL transmission.

17. The UE of claim 11, wherein the transmission handling circuit further:
receives, via the transceiver, a second radio resource control (RRC) to configure resources for the first UL transmission and the second UL transmission.

18. The UE of claim 17, wherein the second RRC comprises a multi-CSI-PUCCH-ResourceList parameter.

19. The UE of claim 11, wherein the transmission handling circuit further:
multiplexes a first channel state information (CSI) report of the first UL transmission with a second CSI report of the second UL transmission.

20. The UE of claim 11, wherein a multi-downlink control information (M-DCI) based multi-TRP (MTRP) scheme is configured to the UE.
